(19) United States
(12) Patent Application Publication
(10) Pub. No.: US 2006/0026224 A1
(43) Pub. Date: Feb. 2, 2006

(54) Method and circuit for combined multiplication and division

(76) Inventor: Patrick Peter Merkli, Baden (CH)

Correspondence Address: George W. Rauchfuss, Jr.;Ohlandt, Greeley, Ruggiero & Perle, L.L.P., Tenth Floor, One Landmark Square, Stamford, CT, 06901-2682, US

(21) Appl. No.: 10/909,154

(22) Filed: Jul. 30, 2004

(51) Int. Cl. G06G 7/00

(52) U.S. Cl. 708/800

(57) ABSTRACT

Previously known analog transistor circuits that compute the “outer product” of two probability mass functions are extended to compute also divisions. Such circuits can be used in hardware implementations of certain algorithms including “generalized belief propagation”, which have applications in many inference problems including the decoding of error correcting codes.

### BACKGROUND OF THE INVENTION

The present invention relates to a circuit and a method for signal processing. In particular, the invention relates to the computation of probability mass functions defined on finite sets. Such functions are of the form p: S→R⁺, where S={s₁, . . . , sₙ} is a finite set, where R⁺ is the set of nonnegative real numbers, and where the function p satisfies the condition
Σ_{k=1 . . . n} p(sₖ)=1. (1)

Such a function can be represented by a list (or vector) of function values (p(s₁), . . . , p(sₙ)). For sums as in (1), the simplified notation
Σₛ p(s)=Σ_{k=1 . . . n} p(sₖ) (2)
will also be used.

In previous work (U.S. Pat. No. 6,282,559 B1; H.-A. Loeliger, F. Lustenberger, M. Helfenstein, and F. Tarkoy, “Probability propagation and decoding in analog VLSI”, Proc. 1998 IEEE Int. Symp. Inform. Th., Cambridge, Mass., USA, Aug. 16-21, 1998, p. 146; H.-A. Loeliger, F. Lustenberger, M. Helfenstein, F. Tarkoey, “Probability Propagation and Decoding in Analog VLSI,”, IEEE Transactions on Information Theory, vol. 47, no. 2, pp. 837-843, February 2001; F. Lustenberger, “On the Design of Analog VLSI Iterative Decoders”, PhD Thesis no. 13879, ETH Zurich, November 2000) analog transistor circuits were presented to compute a probability mass function p_{Z} (defined on some finite set S_{Z}={z₁, . . . , z_{K}}) from two probability mass functions p_{X} (defined on S_{X}={x₁, . . . , x_{M}}) and y (defined on S_{Y}={y₁, . . . , y_{N}}) according to the formula

$${P}_{Z} ( {z}_{k} ) = γ {\sum }_{i = 1 … M} {\sum }_{j = 1 … N} {p}_{X} ( {x}_{i} ) {p}_{Y} ( {y}_{j} ) f ( {x}_{i} , {y}_{j} , {z}_{k} ) \qquad ( 3 )$$

or, equivalently,
p_{Z}(z)=γΣₓΣ_{y}p_{X}(x)p_{Y}(y)f(x,y,z), (4)
where f is some (arbitrary) {0,1}-valued function (i.e. a function that returns either 0 or 1) and where y is a suitable scale factor such that Σ_{z} p_{Z}(z)=1. Computations of the form (3) or (4) are the heart of the generic sum-product probability propagation algorithm, which has many applications including, in particular, the decoding of error correcting codes (see references cited above as well as H.-A. Loeliger, “An introduction to factor graphs,”, IEEE Signal Proc. Mag., January 2004, pp. 28-41).

The core of the circuits proposed in U.S. Pat. No. 6,282,559 is shown in FIG. 1. The input to this circuit are the two current vectors I_{X}(p_{X}(x₁), . . . , p_{X}(x_{M})) and I_{Y}(p_{Y}(y₁), . . . , p_{Y}(y_{N})) with arbitrary sum currents I_{X} and I_{Y}, respectively; the output of this circuit are the M-N products p_{X}(xᵢ)p_{Y}(yⱼ), i=1 . . . N, j=1 . . . N, which are represented by currents: the term p_{X}(xᵢ)p_{y}(yⱼ) is represented by the current

I_{S}p_{X}(xᵢ)p_{y}(yⱼ),

with sum current I_{S}=I_{Y}. It is then easy to compute (3) by summing currents. Note that all probabilities are represented as currents and are processed in parallel. The voltages in the circuit represent logarithms of probabilities.

Recent research on improved probability propagation has produced algorithms that require the computation of expressions of the form

$${p}_{Z} ( z ) = γ {\sum }_{x} {\sum }_{y} {\sum }_{w} f ( x , y , z , w ) {p}_{X} ( x ) {p}_{Y} ( y ) / {p}_{W} ( w ) , \qquad ( 5 )$$

where everything is as in (4) except for the division by p_{W}(w), where p_{W} is also a probability mass function.

Examples of such algorithms include “generalized belief propagation” (J. S. Yedidia, W. T. Freeman, and Y. Weiss, “Generalized Belief Propagation”, Advances in Neural Information Processing Systems (NIPS), vol. 13, pp. 689-695, December 2000; R. J. McEliece and M. Yildirim, “Belief propagation on partially ordered sets”, in Mathematical Systems Theory in Biology, Communication, Computation, and Finance, J. Rosenthal and D. S. Gilliam, eds., IMA Volumes in Math. and Appl., vol. 134, Springer Verlag, 2003, pp. 275-299) and “structured-summary propagation” (J. Dauwels, H.-A. Loeliger, P. Merkli, and M. Ostojic, “On structured-summary propagation, LFSR synchronization, and low-complexity trellis decoding”, Proc. 41st Allerton Conf. on Communication, Control, and Computing. Monticello, Ill., Oct. 1-3, 2003, pp. 459-467). Such algorithms cannot be implemented by the circuit of FIG. 1.

### BRIEF SUMMARY OF THE INVENTION

Hence, it is a general object of the invention to provide a circuit and method able to calculate terms as shown in (5).

Now, in order to implement these and still further objects of the invention, which will become more readily apparent as the description proceeds, in a first aspect the invention relates to a circuit for signal processing that comprises at least one circuit section, each circuit section comprising
Q first inputs a₁ . . . a_{Q},
R second inputs b₁ . . . b_{R},
a third input c,
RXQ outputs d₁₁ . . . d_{QR},
RXQ first transistors T₁₁ . . . T_{QR}, a gate of each first transistor Tᵢⱼ being connected to the first input aᵢ, a source of each first transistor Tᵢⱼ being connected to the second input bⱼ, and a drain of each first transistor Tᵢⱼ being connected to the output dᵢⱼ,
Q second transistors TX₁ . . . TX_{Q}, a gate and a drain of each second transistor TXᵢ being connected to the first input aᵢ and a source of each second transistor TXᵢ being connected to the third input c,
R third transistors TY₁ . . . TY_{R}, a gate and a drain of each third transistor TY₁ being connected to a reference voltage and a source of each third transistor TYⱼ being connected to the second input bⱼ, and a fourth transistor TW, a gate and a drain of the fourth transistor TW being connected to the reference voltage and a source of the fourth transistor TW being connected to the third input c.

In a further aspect, the invention relates to a method for the parallel processing of terms
p_{X}(xₘ)p_{Y}(yₙ)/p_{W}(wₖ)
where, p_{X}(xₘ), p_{y}(yₙ) and p_{W}(wₖ) are non-negative real-valued functions, xₘ stands for an element {x₁ . . . x_{M}} of a first finite set having M elements, yₙ stands for an element {y₁ . . . y_{N}} of a second finite set having N elements and wₖ stands for an element {w₁ . . . w_{L}} of a third finite set having L elements, wherein a plurality of the terms with differing i, j and k are calculated by providing a circuit comprising L circuit sections, wherein each circuit section comprises
Q≦M first inputs a₁ . . . a_{Q},
R≦N second inputs b₁ . . . b_{R},
a third input c,
RXQ outputs d₁₁ . . . d_{QR},
RXQ first transistors T₁₁ . . . T_{QR}, a gate of each first transistor Tᵢⱼ being connected to the first input aᵢ, a source of each first transistor Tᵢⱼ being connected to the second input bⱼ, and a drain of each first transistor Tᵢⱼ being connected to the output dᵢⱼ,
Q second transistors TX₁ . . . TX_{Q}, a gate and a drain of each second transistor TXᵢ being connected to the first input aᵢ and a source of each second transistor TXᵢ being connected to the third input c,
R third transistors TY₁ . . . TY_{R}, a gate and a drain of each third transistor TYⱼ being connected to a reference voltage and a source of each third transistor TYⱼ being connected to the second input bⱼ, and a fourth transistor TW, a gate and a drain of the fourth transistor TW being connected to the reference voltage and a source of the fourth transistor TW being connected to the third input c, said method further comprising the steps of
feeding a current proportional to p_{X}(xₘ) to each of said first inputs aᵢ,
feeding a current proportional to p_{Y}(yₙ) to each of said second inputs bⱼ,
feeding a current proportional to p_{W}(wₖ) to each of said third inputs c,
thereby generating a plurality of currents proportional to a plurality of said terms at said outputs.

In yet a further aspect, the invention relates to a method for calculating a probability mass function p_{z}(z) on a finite set S_{z} from
p_{Z}(z)=γΣₓΣ_{y} Σ_{w} f(x,y,z,w) p_{X}(x)p_{Y}(y)/p_{W}(w),
wherein p_{X}(x), P_{Y}(y) and p_{W}(w) are probability mass functions defined on finite sets S_{X}, S_{Y} and S_{W}, and f(x,y,z,w) is a {0, 1}-valued function, and where γ is a scaling factor, said method comprising the steps of the method of the second aspect as well as the step of adding at least some of the currents at the outputs d₁₁ . . . d_{QR}.

As is shown below, the desired terms can be calculated efficiently with one or more of the described circuit sections.

The term “transistor” in the present text and claims is to be understood to designate any type of transistor, such as a FET transistor or a bipolar transistor, as well as a combination of individual transistors having equivalent properties, such as a Darlington transistor or a cascode.

The term “gate” in the present text and claims refers to the control input of a transistor. Since the transistors used in the present invention can be FET as well as bipolar transistors, the term “gate” is also to be understood as designating the base if bipolar transistors are used. Similarly, the terms “drain” and “source” are to be understood as designating the collector and emitter, respectively, if bipolar transistors are used.

### BRIEF DESCRIPTION OF THE DRAWINGS

The invention will be better understood and objects other than those set forth above will become apparent when consideration is given to the following detailed description thereof. Such description makes reference to the annexed drawings, wherein:

FIG. 1 shows a prior art multiplier,

FIG. 2 shows a circuit for 8 input values and 18 output values,

FIG. 3 shows a circuit for 10 input values and 8 output values calculating part of the corresponding product ratio terms,

FIG. 4 shows one circuit section of a generalized version of the circuit of FIG. 2,

FIG. 5 is a component of an application of the invention, and

FIG. 6 shows an application of the invention.

### DETAILED DESCRIPTION OF THE INVENTION

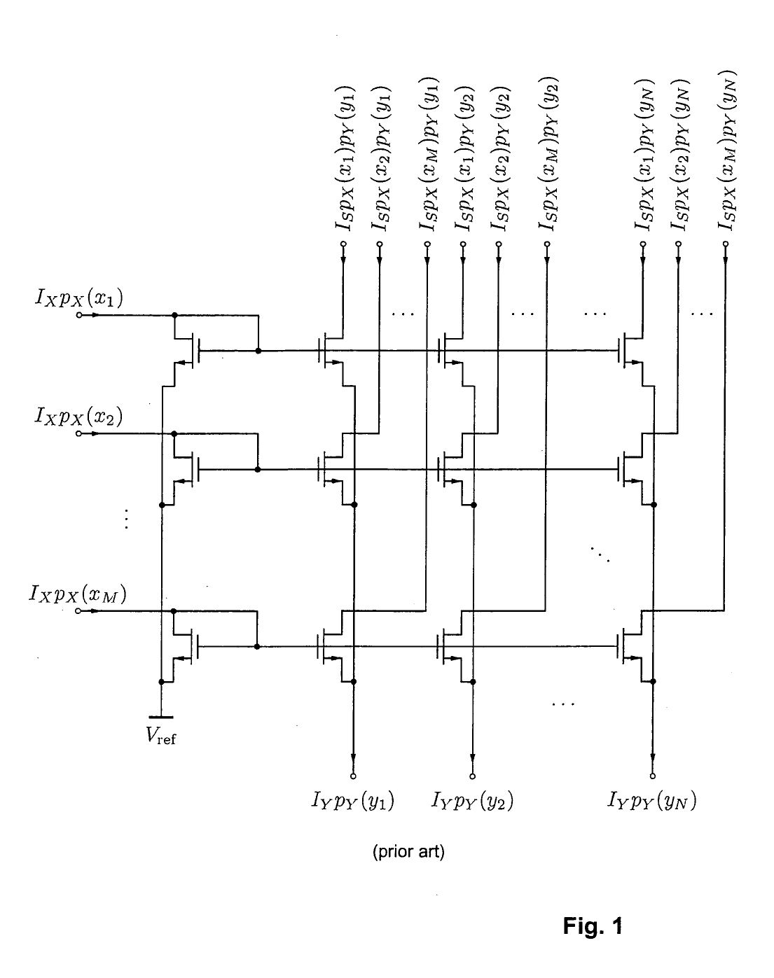

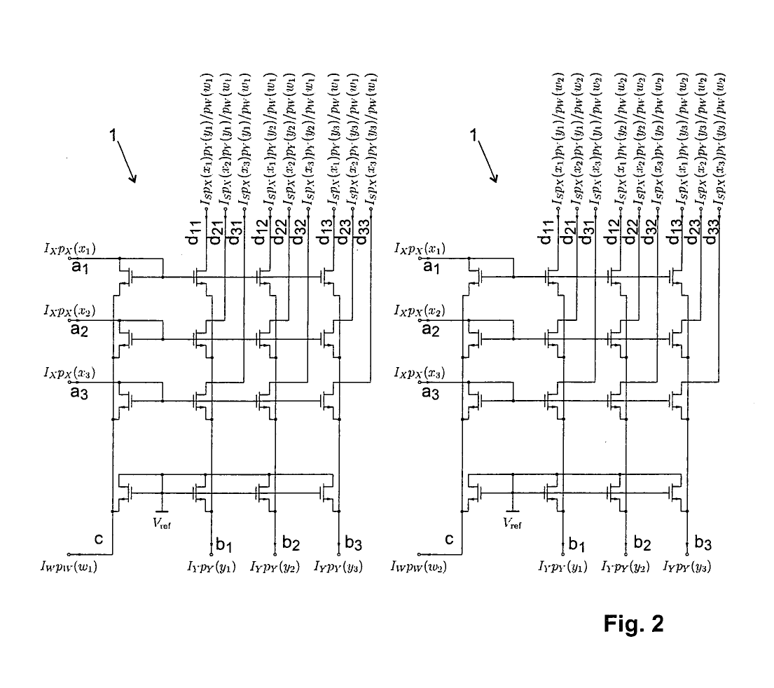

The invention provides a circuit to produce output currents
I_{S}p_{Z}(x)p_{Y}(y)/p_{W}(w) (6)
(for some reference current I_{S}) for all x, y, and w in parallel. FIG. 2 shows an example of such a circuit where the sets S_{X} and S_{Y} both have M=N=3 elements and the set S_{W}={w₁, . . . , w_{L}} (the domain of p_{W}) has L=2 elements. To compute (5), the required output currents can be summed. As the original circuit of FIG. 1, copies of the new circuit of FIG. 2 can easily be connected (and combined with circuits as in FIG. 1) to large networks.

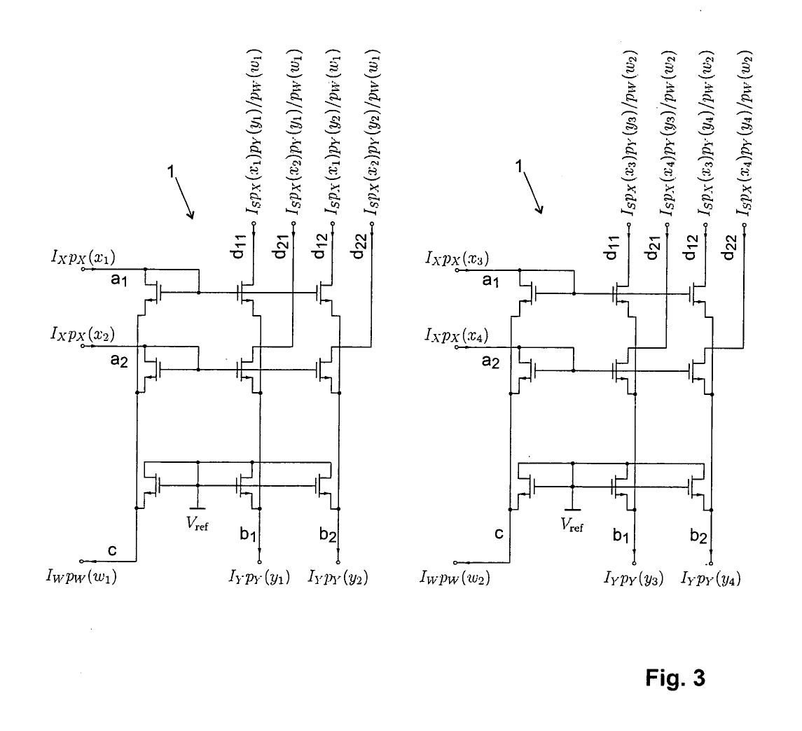

If some term p_{X}(x)p_{Y}(y)/p_{W}(w) is not used in this sum, the corresponding current must flow nonetheless; this may be achieved by connecting the corresponding output to some suitable reference voltage. However, if, for some fixed x, no such term is used, then the corresponding row of transistors may be omitted. Similarly, if, for some fixed y, no such term is used, then the corresponding column of transistors may be omitted. This is illustrated in FIG. 3 where M=N=4, but only the terms
p_{X}(x₁)p_{Y}(y₁)/p_{W}(w₁), p_{X}(x₁)p_{Y}(y₂)/p_{W}(w₁), p_{X}(x₂)p_{Y}(y₁)/p_{W}(w₁), p_{X}(x₂)p_{Y}(y₂)/p_{W}(w₁), p_{X}(x₃)p_{Y}(y₃)/p_{W}(w₂), p_{X}(x₃)p_{Y}(y₄)/p_{W}(w₂), p_{X}(x₄)p_{Y}(y₃)/p_{W}(w₂), p_{X}(x₄)p_{Y}(y₄)/p_{W}(w₂), are used.

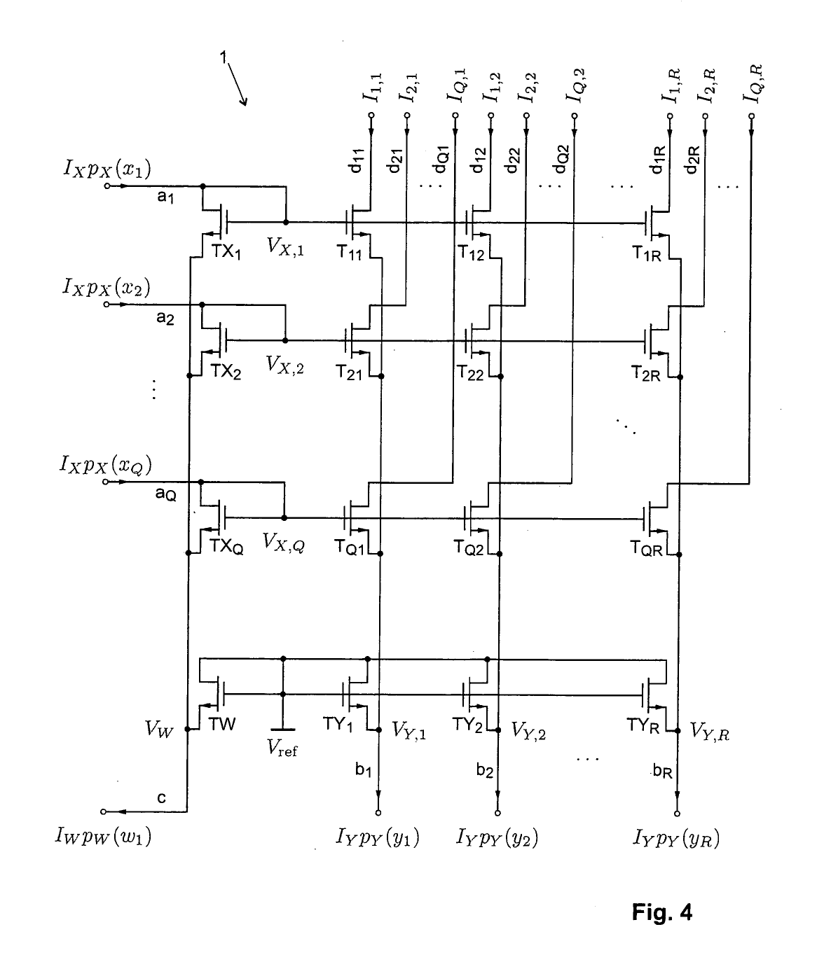

The new circuit (exemplified by FIGS. 2 and 3) works as follows. First, we note that it consists of L circuit sections 1, where L is the cardinality of SW. In most applications, we have L>2. The general form of one such circuit section is shown in FIG. 4. The circuit section of FIG. 4 has
2≦Q≦M first inputs a₁ . . . a_{Q} —in the example of FIG. 4 they carry the currents IₓPₓ(x₁) . . . IₓPₓ(x_{Q}); in general, the first inputs a₁ . . . a_{Q} carry the currents belonging to a subset of set S_{X}, wherein each first input carries the current belonging to a different member of set S_{X};
2<R<N second inputs b₁ . . . bR—in the example of FIG. 4 they carry the currents I_{y}P_{y}(y₁) . . . I_{y}P_{y}(y_{R}); in general, the second inputs b₁, . . . b_{R} carry the currents belonging to a subset of set S_{Y}, wherein each first input carries the current belonging to a different member of set S_{Y};
a third input c—in the example of FIG. 3 it carries the current I_{W}P_{W}(w₁); in general, the third input c of the n-th circuit section 1 carries the current I_{W}P_{W}(wₙ);
RxQ outputs d₁₁ . . . d_{QR} carrying currents I_{1,1} . . . I_{Q,R}, which correspond to the terms (6) calculated for the applied inputs,
RxQ first transistors T₁₁ . . . T_{QR}, the gate of each first transistor Tᵢⱼ being connected to the first input aᵢ, the source to the second input bⱼ, and the drain to the output dᵢⱼ,
Q second transistors TX₁ . . . T_{XQ}, the gate and the drain of each second transistor T_{Xi} being connected to the first input aᵢ and the source to the third input c,
R third transistors TY₁ . . . TY_{R}, the gate and the drain of each third transistor TYⱼ being connected to a reference voltage V_{ref} and the source to the second input bⱼ, and
a fourth transistor TW, the gate and the drain of which is connected to the reference voltage V_{ref} and the source to the third input c.

All L circuit sections are of the same design but may have different R and Q.

We assume that all the transistors function as voltage controlled current sources with an exponential relation between the current and the control voltage.

This assumption holds both for bipolar transistors and for MOS-FET transistors in weak inversion. In the following we use the notation for MOS-FET transistors:
I_{drain}=I₀ exp((κ·V_{gate}−V_{source})/U_{T}), (7)
where I_{drain} is the drain current, V_{gate} is the gate potential, V_{source} is the source potential, U_{T} is the thermal voltage, I₀ is some technology dependent current, and K is some technology dependent dimensionless constant. The currents and voltages in FIG. 3 then satisfy both

$$\begin{matrix}\begin{matrix}{I}_{i , j} / ( {I}_{Y} {p}_{Y} ( {y}_{j} ) ) = \{ {I}_{0} exp ( ( κ \cdot {V}_{X , i} - {V}_{Y , j} ) / {U}_{T} ) \} / \\ \{ {I}_{0} exp ( ( κ \cdot {V}_{ref} - {V}_{Y , j} ) / {U}_{T} ) + \\ {\sum }_{k = 1 … Q} {I}_{0} exp ( ( κ \cdot {V}_{X , k} - {V}_{y , j} ) / {U}_{T} ) \} \\ = exp ( κ \cdot {V}_{X , i} / {U}_{T} ) / \{ exp ( κ \cdot {V}_{ref} / {U}_{T} ) + \\ {\sum }_{k = 1 … Q} exp ( κ \cdot {V}_{X , k} / {U}_{T} ) \}\end{matrix} \\ and & ( 8 ) \\ \begin{matrix}{I}_{X} {p}_{X} ( {x}_{i} ) / ( {I}_{W} {p}_{W} ( {w}_{1} ) ) = \{ {I}_{0} exp ( ( κ \cdot {V}_{X , i} - {V}_{W} ) / {U}_{T} ) \} / \\ \{ {I}_{0} exp ( ( κ \cdot {V}_{ref} - {V}_{W} ) / {U}_{T} ) + \\ {\sum }_{k = 1 … Q} {I}_{0} exp ( ( κ \cdot {V}_{X , k} - {V}_{W} ) / {U}_{T} ) \} \\ = exp ( κ \cdot {V}_{X , i} / {U}_{T} ) / \{ exp ( κ \cdot {V}_{ref} / {U}_{T} ) + \\ {\sum }_{k = 1 … Q} exp ( κ \cdot {V}_{X , k} / {U}_{T} ) \}\end{matrix} & ( 9 )\end{matrix}$$

The right-hand sides of (8) and (9) are identical, which implies
I_{i,j}/(I_{Y}p_{Y}(yⱼ))=I_{X}p_{X}(xᵢ)/(I_{W}p_{W}(wᵢ)) (10)
or
I_{i,j}=I_{X}·I_{Y}/I_{W}·p_{X}(xᵢ)·p_{Y}(yⱼ)/p_{w}(w₁). (11)
Note that (11) is equivalent to (6) with I_{S}=I_{X}·I_{Y}/I_{W}.

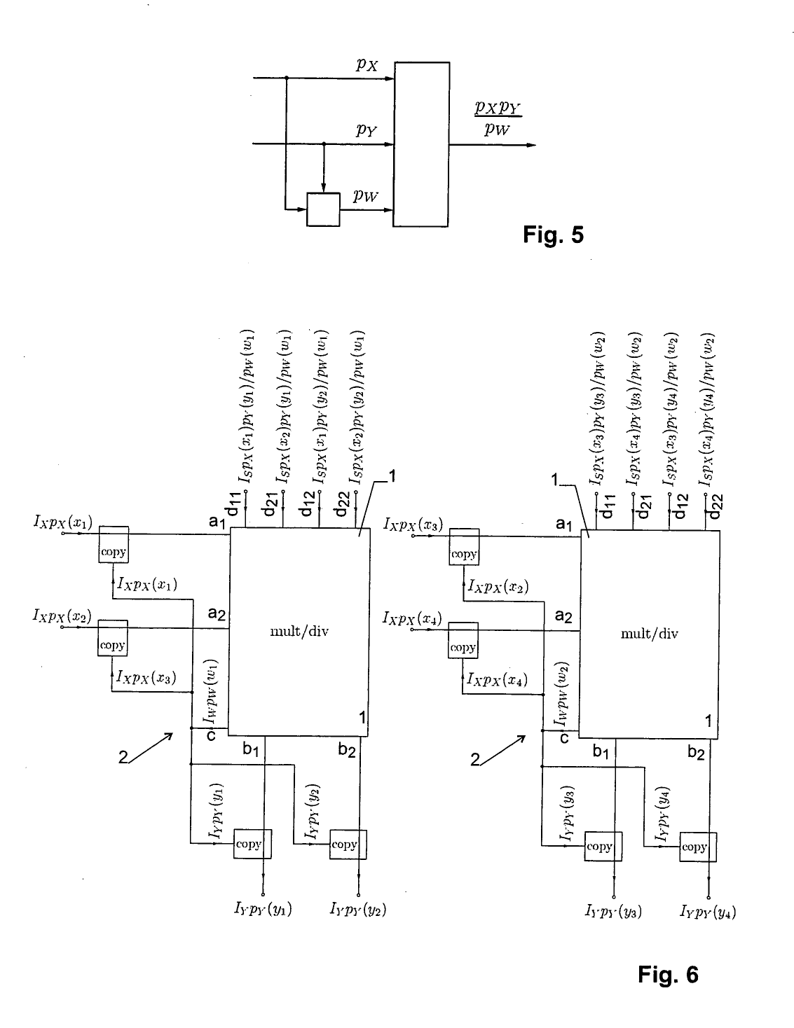

There is a small catch: the above analysis holds only if the condition
I_{W}p_{W}(w₁)≧Σ_{k=1 . . . Q} I_{X}p_{X}(xₖ) (12)
is satisfied. In other words, the current fed to the third input c exceeds the sum of the currents fed to the first inputs aᵢ. It should therefore be pointed out that, in algorithms as in J. Dauwels, H.-A. Loeliger, P. Merkli, and M. Ostojic cited above, the probability distribution P_{W} in (5) is not an independent input, but is derived from p_{X} and p_{Y} applied to the same circuit section 1, as is shown in FIG. 5. In such applications, the condition (12) may be satisfied automatically. For example, let M=N=4 and L=2 and assume that p_{W} is defined by
p_{W}(w₁)=(1/2)·(p_{X}(x₁)+p_{X}(x₂)+p_{Y}(y₁)+p_{Y}(y₂))
and
p_{W}(w₂)=(1/2)·(p_{X}(x₃)+p_{X}(x₄)+p_{Y}(y₃)+p_{Y}(y₄)).
(In other words, p_{W} is an average of two marginal distributions derived from p_{X} and from p_{Y}, respectively; or, in yet other words, each value p_{W}(wₖ) is proportional to a sum of part of the values p_{X}(xₘ) and part of the values p_{Y}(yₙ), namely of those values that are fed to the same circuit section 1 as the given P_{W}(wₖ).)

This may be realized as shown in FIG. 6 with input sum currents I_{X}=I_{Y}. The sections 1 labeled “mult/div” represent a section 1 as shown in FIG. 4 (one half of FIG. 3) and the blocks labeled “copy” produce a copy of the current passed through it. The copied currents are added in an adder 2 by applying them in parallel to the input c. An adder is attributed to each circuit section 1. The outputs cᵢⱼ of the circuit are proportional to
p_{X}(x₁)p_{Y}(y₁)/p_{W}(w₁), p_{X}(x₁)p_{Y}(y₂)/p_{W}(w₁), p_{X}(x₂)p_{Y}(y₁)/p_{W}(w₁), p_{X}(x₂)p_{Y}(y₂)/p_{W}(w₁), p_{X}(x₃)p_{Y}(y₃)/p_{W}(w₂), p_{X}(x₃)p_{Y}(y₄)/p_{W}(w₂), p_{X}(x₄)p_{Y}(y₃)/p_{W}(w₂), p_{X}(x₄)p_{Y}(y₄)/p_{W}(w₂),
   represented as currents with some common sum current Is.

In the examples of FIGS. 3 and 6, the numbers M and N divisible by L (which is equal to 2 in both embodiments) and we have Q=M/L and R=N/L for each circuit section. This is typical for most probability computations.

While there are shown and described presently preferred embodiments of the invention, it is to be distinctly understood that the invention is not limited thereto but may be otherwise variously embodied and practised within the scope of the following claims.

1. A circuit for signal processing, wherein said circuit comprises at least one circuit section, each circuit section comprising
Q first inputs a₁ . . . a_{Q},
R second inputs b₁ . . . b_{R},
a third input c,
RXQ outputs d₁₁ . . . d_{QR},
RXQ first transistors T₁₁ . . . T_{QR}, a gate of each first transistor Tᵢⱼ being connected to the first input aᵢ, a source of each first transistor Tᵢⱼ being connected to the second input bⱼ, and a drain of each first transistor Tᵢⱼ being connected to the output dᵢⱼ,
Q second transistors TX₁ . . . TX_{Q}, a gate and a drain of each second transistor TXᵢ being connected to the first input aᵢ and a source of each second transistor TXᵢ being connected to the third input c,
R third transistors TY₁ . . . TY_{R}, a gate and a drain of each third transistor TYⱼ being connected to a reference voltage and a source of each third transistor TYⱼ being connected to the second input bⱼ, and
a fourth transistor TW, a gate and a drain of the fourth transistor TW being connected to the reference voltage and a source of the fourth transistor TW being connected to the third input c.

2. The circuit of claim 1 comprising L>2 of said circuit sections.

3. The circuit of claim 1 wherein said first, second, third and fourth transistors are voltage controlled current sources with a substantially exponential relation between a current through the drain and a voltage at the gate.

4. The circuit of claim 1 wherein said transistors are FET transistors.

5. The circuit of claim 1 wherein said transistors are bipolar transistors.

6. The circuit of claim 2 wherein M and N are divisible by L and Q=M/L and R=N/L.

7. The circuit of claim 1 further comprising an adder attributed to each circuit section for feeding a current to the third input c, which current is proportional to a sum of the currents fed to the first and the second inputs a₁ . . . a_{Q} and b₁ . . . b_{R}.

8. The circuit of claim 1 wherein Q≧2 and R≧2.

9. A method for the parallel processing of terms
p_{X}(xₘ)p_{Y}(yₙ)/p_{W}(wₖ)
where, p_{X}(xₘ), p_{Y}(yₙ) and p_{W}(wₖ) are non-negative real-valued functions, xₘ stands for an element {x₁ . . . X_{M}} of a first finite set having M elements, yₙ stands for an element {y₁ . . . y_{N}} of a second finite set having N elements and wk stands for an element {w₁ . . . w_{L}} of a third finite set having L elements, wherein a plurality of the terms with differing i, j and k are calculated in parallel by providing a circuit comprising L circuit sections, wherein each circuit section comprises
Q≦M first inputs a₁ . . . a_{Q},
R≦N second inputs b₁ . . . b_{R},
a third input c,
RXQ outputs d₁₁ . . . d_{QR},
RXQ first transistors T₁₁ . . . T_{QR}, a gate of each first transistor Tᵢⱼ being connected to the first input aᵢ, a source of each first transistor Tᵢⱼ being connected to the second input bⱼ, and a drain of each first transistor Tᵢⱼ being connected to the output dᵢⱼ,
Q second transistors TX₁ . . . TX_{Q}, a gate and a drain of each second transistor TX₁ being connected to the first input aᵢ and a source of each second transistor. TXᵢ being connected to the third-input c,
R third transistors TY₁ . . . TY_{R}, a gate and a drain of each third transistor TYⱼ being connected to a reference voltage and a source of each third transistor TYⱼ being connected to the second input bⱼ, and
a fourth transistor TW, a gate and a drain of the fourth transistor TW being connected to the reference voltage and a source of the fourth transistor TW being connected to the third input c,
said method further comprising the steps of
feeding a current proportional to pₓ(xₘ) to each of said first inputs aᵢ,
feeding a current proportional to p_{Y}(yₙ) to each of said second inputs bⱼ,
feeding a current proportional to p_{W}(wₖ) to each of said third inputs c,
thereby generating a plurality of currents proportional to a plurality of said terms at said outputs.

10. The method of claim 9 wherein L≧2.

11. The method of claim 9 wherein M and N are dividable by L and Q=M/L and R=N/L.

12. The method of claim 9 wherein each value p_{W}(wk) is proportional to a sum of at least part of the values p_{X}(xₘ) and at least part of the values p_{Y}(yₙ).

13. The method of claim 12 wherein p_{W}(wₖ) is set to be proportional to the sum of the values that are fed to the same circuit section as the value p_{W}(wₖ).

14. The method of claim 9 wherein the current fed to said third input exceeds a sum of the currents fed to said first inputs.

15. The method of claim 9 wherein Q≧2 and R≧2.

16. A method for calculating a probability mass function p_{Z}(z) on a finite set S_{z} from
p_{Z}(z)=γΣₓΣ_{y}Σ_{w}f(x,y,z,w) p_{X}(x)p_{Y}(y)/p_{W}(w),
wherein p_{X}(x), p_{Y}(y) and p_{W}(w) are probability mass functions on finite sets S_{X}, S_{Y} and S_{W}, and f(x,y,z,w) is a {0, 1} valued function, and where y is a scaling factor, said method comprising the steps of the method of claim 9 as well as the step of adding at least some of the currents at the outputs d₁₁ . . . d_{QR}.
